(19) United States
(12) Patent Application Publication
(10) Pub. No.: US 2007/0082220 A1
(43) Pub. Date: Apr. 12, 2007

(54) Galvanized steel with brushed gloss finish and process to form the steel

(75) Inventor: Santiago Elizandro Gonzalez Ramos, Nuevo Laredo (MX)

Correspondence Address: John S. Egbert;Egbert Law Offices, 7th Floor, 412 Main Street, Houston, TX, 77002, US

(73) Assignee: Industrias Monterrey, S.A. de C.V. (IMSA-MEX,S.A. DE C.V.), San Nicolas de los Garza (MX)

(21) Appl. No.: 11/402,212

(22) Filed: Apr. 11, 2006

(30) Foreign Application Priority Data
Oct. 7, 2005 (MX) NL/A/2005/000081

(51) Int. Cl. B32B 15/00

(52) U.S. Cl. 428/658; 428/612

(57) ABSTRACT

Galvanized steel having a brushed gloss finish is formed by a brushed galvanic coating, being generally uniform and having not-remarked Zinc Micro crystals and at least one clear organic coating over the galvanic coating. The galvanized steel with brushed gloss finish is obtained by the process of developing a layer of Zinc Micro crystals over the galvanic coating applied on steel; hardening with gloss finish such galvanic coating; brushing the coating; avoiding remarking edges of the Zinc Micro crystal applied on the galvanic coating; and applying at least one clear and/or pigmented clear organic coating.

### RELATED U.S. APPLICATIONS

Not applicable.

### Statement Regarding Federally Sponsored Research or Development

Not applicable.

### Reference to Microfiche Appendix

Not applicable.

### FIELD OF THE INVENTION

This invention refers to the technical field of producing galvanized steel and particularly, to the process to obtain galvanized steel having a brushed gloss finish with appearance similar or superior to stainless steel.

### BACKGROUND OF THE INVENTION

Currently, in galvanic coatings based on zinc or having zinc-alloys over metal substrates, a gloss coat is the most wanted finish, to give to galvanized items a decorative and improved presentation, in other words; in addition to its anti-corrosive effect, a decorative effect is also pursued.

To achieve this effect it is essential to add in zinc coatings certain auxiliary products, since otherwise, in most cases, zinc coatings will end with a glossless or irregular finish. A group of such auxiliary products for acid zinc coatings are, for example, conductive salts that are used to improve coating conductivity, and another group of auxiliary agents called promoting gloss agents. Examples of these applications are found in the following documents.

Joachim Korpium & Joachim Steeg in the patent from the United States of America U.S. Pat. No. 3,694,330 describe acid and galvanic-zinc coatings containing ammonic salts and aromatic carbonilic compounds as promoting gloss agents. Some substances mentioned for these ones are, aromatic carboxylic acids and aromatic aldehydes and ketones. More specifically mentioned, among others, are cinnamic acid, cinnamic aldehyde, benzoic acid, benzalacetone, and ethyl ester of benzoyl acetic acid.

Charles W. Welch in patent from the United States of America, U.S. Pat. No. 4,422,908 describes galvanic and acid zinc-coatings, that contain sulfamate ions and as promoting gloss agents aromatic carbonilic compounds. This patent indicates aldehydes and ketones, and benzalacetone as preferable substance from these chemicals.

Erwin Hahn and partners in the publication of European patent EP-0,588,805 describe the production of shaped pieces with gloss galvanic or zinc-alloy coatings through the electrolytic separation of zinc or zinc alloys of galvanic coatings (aqueous or acid), containing as essential components one or several zinc salts and in any case salts from another metal alloy, one or several conducting salts, one or several surface-active agents or one or several promoting gloss agents. As promoting gloss agent, they use preferably ethyl and methyl ester of 2-benzyliden acetoacetic acid and diethyl and dimethyl ester of 2-benzyliden malonic acid.

Erin T. McDevitt and Scott A. Kriner in patent from the United States of America U.S. Pat. No. 6,440,582 81 describe a process to galvanize steel products using aluminum and zinc alloys, the process includes modifying the composition of the galvanic coating in order to reduce crystallization and offer a brushed surface finish that improves its aspect once it is painted. The composition of the galvanic coating includes borides such as titanium boride and aluminum boride, carbides such as titanium carbide and aluminides such as titanium aluminide. The process does not require hardening the coating to paint it.

Another modem option to obtain a gloss finish consists in applying paint-based coverings over galvanized coatings. Such as the one described by Shioda Hidemasa in Japanese patent JP-11 ,207,861, in which to provide a texture similar to a stainless steel sheet or aluminum sheet through rollers and successive drying stages, a first coating of polyester is applied over the surface of the galvanized steel sheet to apply then a second coating based on aluminum powder over which a striped pattern is printed to subsequently form a third coating based on a polyester covering.

Currently, it is very common to apply a brushing process to the galvanized coating to improve the bonding of paint based coverings over it. It can be seen in the description of Suzukawa Hiroyoshi and Koga Takeshi in Japanese patent JP-61,096,084, that they describe that galvanized steel sheets are brushed after being treated with a phosphate-base coating such as sodium phosphate or titanium phosphate. This allows giving color to the galvanic coating and improves in this manner paint adherence over its surface.

The options described above show certain limitations such as alteration of zinc-coating basic composition, the use of toxic substances and repainting or color-improvement processes; therefore, based on these limitations, it is necessary to offer a process to obtain galvanized steel with a brushed gloss finish at low cost and easy implementation in current production lines of galvanized products, without modifying galvanic coating composition nor using repainting processes, but at the same time that allows obtaining a galvanized steel with a gloss finish of similar or better appearance than stainless steel.

### BRIEF SUMMARY OF THE INVENTION

Based on the conditions described above, and with the purpose of giving answer to the limitations found, this invention intends to offer a process for obtaining galvanized steel with a brushed gloss finish. The process will have the steps of developing a layer of Zinc Micro crystals in the galvanic coating applied on steel; hardening such galvanic coating giving it a gloss finish; brushing such galvanic coating; and avoiding edge remarking of such Zinc Micro crystals on the galvanic coating; and applying at least a clear and/or pigmented clear organic coating.

This invention also has the purpose of offering galvanized steel with a brushed gloss finish, having a generally uniform brushed galvanized coating made-up by not-remarked Zinc Micro crystals; and at least a clear and/or pigmented clear organic coating.

### BRIEF DESCRIPTION OF THE SEVERAL VIEWS OF THE DRAWINGS

The characteristic details of this invention are described in the following paragraphs together with their related figures, which have the purpose of defining the invention but not limiting its scope.

FIG. 1 shows a schematic view of a block chart of a process for obtaining galvanized steel having a brushed gloss finish according to this invention.

FIGS. 2A to 2E are photographic views displaying a series of microscope photographs that show surface finish of galvanized steel according to each process step of the invention indicated in FIG. 1.

FIGS. 3A and 3B are photographic views illustrating photographs that show surface finish of galvanized steel obtained according to the invention (FIG. 3A) compared to regular stainless steel surface finish (FIG. 3B).

### DETAILED DESCRIPTION OF THE INVENTION

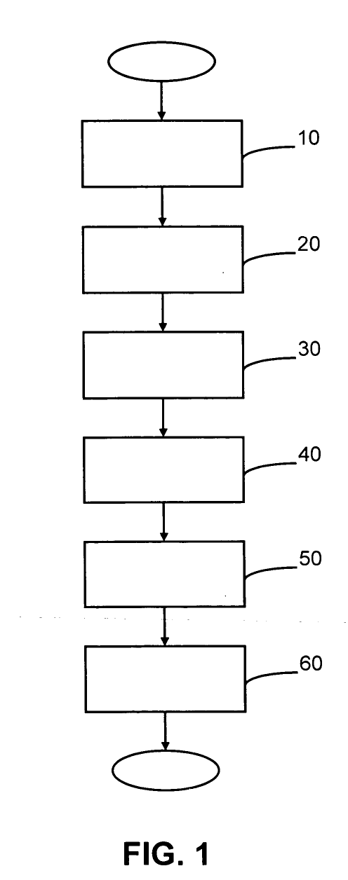

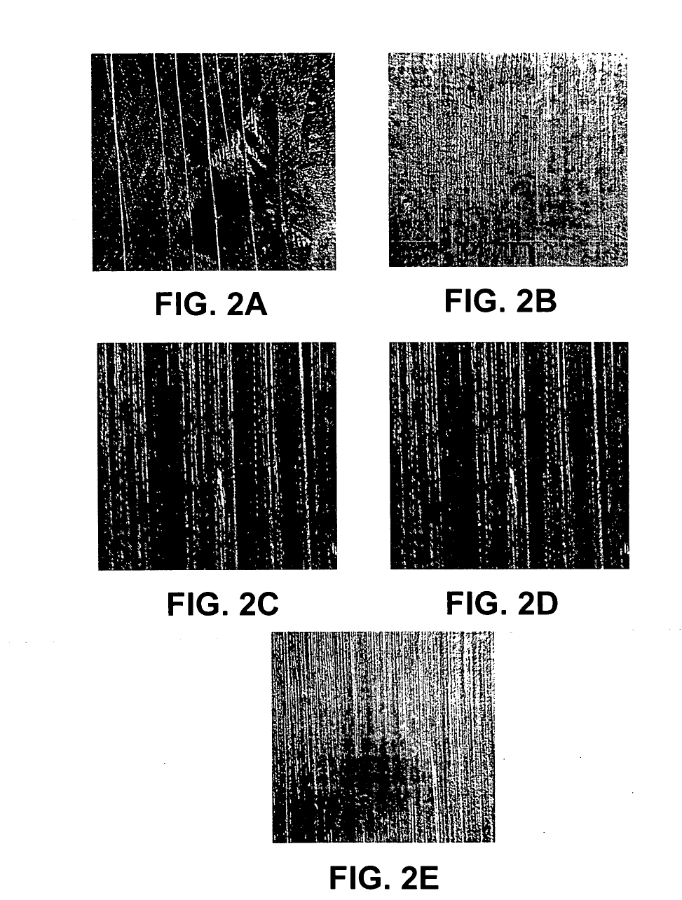

Taking as reference FIGS. 1 and 2A to 2E as a set, the process for obtaining galvanized steel with a brushed gloss finish, according to this invention, begins in step 10 where the carbon steel, with a the carbon concentration running from 0.002% for deep die-cast steel up to 0.10% for hard steels, in sheets of 0.3 mm up to 1.55 mm deep and surface roughness below 1.016 μm, has been previously annealed, either on line or by batch, and passed through a cleaning process to remove rust, crusts, oil, paint and other foreign bodies from its surface, receives a galvanic coating, in at last one of the sheet faces, generally through the galvanization process of hot immersion in an alloy with a minimum of 95% zinc.

In step 20, before the solidification of such galvanic coating, a layer of very fine zinc crystals or Zinc Micro crystals is developed; such micro-crystals have an average size of 0.1 mm to 5 mm, against the 15 to 25 mm that zinc crystals have in regular crystallization processes. To do this micro-crystallization, it may be used the process known in the state of the art in which galvanic coating is attacked with zinc particles with a minimum content of 25% of this element. The surface finish obtained in this process stage can be seen in FIG. 2A.

Once the micro-crystallization and solidification or covering has been performed, the hardening process of this galvanic coating is begun in step 30, together with the reduction of surface roughness and imperfections. This can be made by using gloss finish rollers with a roughness of less than 1.016 μm on which galvanized steel is passed through, this procedure produces a uniform surface in the galvanic coating, free of the deep valleys and pronounced crests caused by crystallization. The surface finish obtained in this process phase is observed in FIG. 28.

In step 40 the galvanic coating is superficially striped or brushed with a specific depth and direction pattern through the use of abrasives such as, emery cloths, rollers, attack with abrasive particles, etc. either by manual or automatic processes. Surface finish obtained in this process stage is observed in FIG. 2C.

Once the galvanic coating surface has been brushed, in step 50, the surface is submitted to a chemical reaction with a chemical reagent based on materials free of heavy metals, phosphates and chrome, preferably with chemical reagents based on silanes such as zirconium, titanium and/or a combination thereof to avoid remarking of Zinc Micro crystal edges in the galvanic coating. The chemical reagent can be applied by immersion of the galvanized steel, applied by rollers or sprayed to be subsequently submitted to a drying procedure. Surface finish obtained in this process stage is observed in FIG. 2D.

Finally, in step 60, over the galvanic coating surface, one or more organic clear and/or pigment transparent coatings are applied. These coverings are based on one or more polymeric organic resins preferably acrylic resins, polyester, epoxy resins, fluorocarbonated resins and mixtures thereof. Once the organic coating has been applied, the sheet is cured in oven at a temperature of about 180° C. to 300° C. The organic coating has a film thickness of less than 25 μm to give a finish gloss of 15 to 80 units measured at 60° having the particularity of avoiding surface stain and increasing resistance to oxidation. Surface finish obtained in this phase of the process is similar or superior to the surface finish of stainless steel, as it may be seen in FIG. 2E.

Once the invention process has been completed, obtained galvanized steel complies with the physical and mechanical properties necessary to be used in house appliances, industrial equipment, electronic and electric appliances, construction applications and architectural projects since during its online annealing process, special mechanical properties may be given thereto.

Table 1 below shows a series of examples of galvanized steels obtained at different operations conditions of the process under this invention, indicating the gloss obtained based on roughness, curing temperature and organic coating, residence time in curing oven and thickness of organic coating.

TABLE 1

| | Example | | | | | |
|---|---|---|---|---|---|---|
| | 1 | 2 | 3 | 4 | 5 | 6 |
| Roughness | 0.254 | 0.254 | 0.254 | 0.254 | 0.713 | 0.713 |
| (μm) | | | | | | |
| Curing oven | 371.11 | 387.77 | 371.11 | 387.77 | 371.11 | 387.77 |
| temperature | | | | | | |
| (° C.) | | | | | | |
| Oven residence | 31 | 31 | 32 | 32 | 32 | 32 |
| time (sec) | | | | | | |
| Thickness | 8.89 | 8.89 | 11.43 | 11.43 | 10.92 | 11.43 |
| of organic | | | | | | |
| coating (μm) | | | | | | |
| Gloss (units | 37.2 | 37.2 | 60 | 59.2 | 65.1 | 64.7 |
| measured | | | | | | |
| at 60°) | | | | | | |

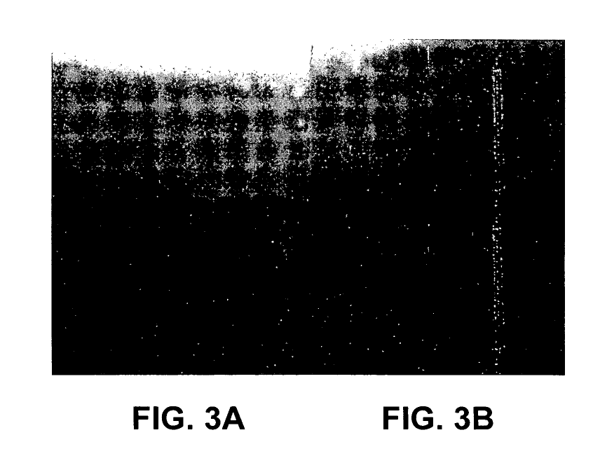

As it is shown in FIG. 3A, galvanized steel with brushed gloss finish is obtained with an appearance similar or superior to stainless steel of FIG. 3B. In this example, the galvanized steel with brushed gloss finish of the invention has a roughness of 1.016 μm and a gloss of 80 units measured at 60°, while stainless steel presents a roughness of 1.25 μm and a gloss of 75 units measured at 60°.

Based on the implementations described above, it is claimed that described modifications of the implementation environments and the alternative implementation environments will be deemed evident for a person expert in the technique craft under this description. Therefore it is deemed that claims encompass such modifications and options under the scope of this invention or its equivalents.

I claim:

1. A process for obtaining galvanized steel with brushed gloss finish, the process comprising the steps of:
developing Zinc Micro crystals in a galvanic coating applied over steel;
hardening said galvanic coating with a gloss finish;
brushing said galvanic coating;
avoiding Zinc Micro crystal edges remarked in said galvanic coating; and
refinishing with at least one organic clear and/or pigment transparent coating.

2. The process of claim 1, wherein the Zinc Micro crystals have a size of about 0.1 mm to 5 mm.

3. The process of claim 1, wherein said galvanic coating has a concentration of at least about 95% of zinc.

4. The process of claim 1, wherein the step of hardening said galvanic coating is comprised of:
passing the galvanized steel through gloss finish rollers to reduce roughness and imperfections of said galvanic coating.

5. The process of claim 1, wherein said galvanic coating has a roughness of less than 1.016 μm approximately.

6. The process of claim 1, wherein the step of brushing such galvanic coating is comprised of:
attacking said galvanic coating by abrasive methods in a pattern of depth and direction.

7. The process of claim 1, herein the step of avoiding remarking of Zinc Micro crystal edges in galvanic coating is comprised of:
making said galvanic coating react chemically with materials free of heavy metals, phosphates and chromium.

8. The process of claim 7, wherein said materials free of heavy metals, phosphates and chromium are selected from a group that consists of:
silanes, such as zirconium, titanium salts and mixtures thereof.

9. The process of claim 1, wherein the clear organic coating is comprised of:
a base of one or more selected polymeric organic resins of the group consisting of acrylic resins, polyester, epoxy resins, fluorocarbonated resins and mixtures thereof.

10. The process of claim 1, wherein the clear organic coating has a thickness close to 5 μm a 25 μm.

11. The process of claim 1, wherein the galvanized steel brushed gloss finish has a gloss close to 15 to 80 units measured at 60°.

12. Galvanized steel with brushed gloss finish comprising:
a galvanic brushed coating, being generally uniform and involving zinc not-remarked micro-crystals; and
at least one clear and/or pigmented clear organic coating.

13. The galvanized steel of claim 12, wherein the Zinc Micro crystals have a size close to 0.1 mm-5 mm.

14. The galvanized steel of claim 12, wherein the galvanic coating has a concentration of at least 95% zinc, approximately.

15. The galvanized of claim 12, wherein the galvanic coating has a roughness lower than 1.106 μm, approximately.

16. The galvanized of claim 12, wherein the galvanic coating has been brushed with a pattern of depth and direction.

17. The galvanized of claim 12, wherein the clear organic coating is comprised of a base of one or more organic polymeric resins.

18. The galvanized steel of claim 12, wherein the clear organic coating has a thickness close to 5 μm-25 μm.

19. The galvanized steel of claim 12, wherein the galvanized steel has a gloss close to 15-80 units measured at 60°.
